(19) United States
(12) Patent Application Publication
(10) Pub. No.: US 2017/0030503 A1
(43) Pub. Date: Feb. 2, 2017

(54) APPARATUS AND METHOD FOR SECURING PIPE HEATERS AND PIPE INSULATION TO PIPE SYSTEMS

(71) Applicant: Edwards Vacuum LLC, Crawley (GB)

(72) Inventors: BUDD EDWARD FAULKNER, Hillsboro, OR (US); JOSHUA MATHEW FIELDS, Hillsboro, OR (US)

(73) Assignee: Edwards Vacuum LLC, Crawley (GB)

(21) Appl. No.: 14/813,223

(22) Filed: Jul. 30, 2015

(51) Int. Cl. F16L 53/00; F16L 59/12; B23P 19/04

(52) U.S. Cl. CPC F16L 53/008; B23P 19/04; F16L 59/12

(57) ABSTRACT

The invention is directed to a pipe heater which includes a heater body to be secured against a pipe, a securing strap system operable to secure the heater body to the: pipe and a self-amalgamating material element provided on the pipe heater to be engaged with a compatible material portion of the pipe heater to lock the securing strap system in a securing condition. The heater body is provided with at least one heating element.

### FIELD OF THE INVENTION

This invention is directed to attaching pipe heaters and pipe insulation to pipe systems including securing pipe heaters and pipe insulation to pipes that are a part of a pipe system.

### BACKGROUND

Many industrial processes require the use of pipes to convey fluids between fluid reservoirs, machines, processing devices and the like. Control of the temperature within the pipe may be desirable. This may be to ensure that the fluids conveyed are maintained in a particular state. For example, processes used in the manufacture of semiconductors may involve the use of gases that become dangerous if allowed to condense in the pipes through which they are supplied. Explosion hazards, corrosive media and other such hazards may exist if such gases are allowed to condense on the pipe walls. Pipes may be provided with electric heaters to warm the pipe walls to prevent condensation of the conveyed gases. Often, numerous electric heaters are provided along a length of pipe.

As can be seen, there is a need in the industry for securing heaters to a pipe by means of straps that wrap around the heater and the pipe. In some examples, one end of a strap is provided with two D-rings through which the other end of the strap can be threaded to tighten the strap and secure the heater to the pipe.

Other objects, aspects and advantages of this invention will be apparent to one skilled in the art in view of the following disclosure, the drawings, and the appended claims.

### BRIEF DESCRIPTION OF THE DRAWINGS

In the following disclosure, reference will be made to the drawings, in which:

FIG. 1 is a schematic illustration of a pipe heater with a view from one side;

FIG. 2 is a schematic illustration of the pipe heater of FIG. 1 with a view from the opposite side;

FIG. 3 is a schematic illustration of a portion of a securing strap system of the pipe heater of FIG. 1 and a pipe;

FIG. 4 is a schematic illustration showing the pipe heater of FIG. 1 secured to a pipe;

FIG. 5 is a schematic illustration of another pipe heater with a view from one side;

FIG. 6 is a schematic illustration of a pipe insulator with a view from one side; and

FIG. 7 is a schematic illustration of the pipe insulator of FIG. 6 with a view from the opposite side.

### SUMMARY OF THE INVENTION

The summary of the invention is intended to introduce the reader to various exemplary aspects of the invention. Particular aspects of the invention are shown in other sections herein below, and the invention is set forth in the appended claims which alone demarcate its scope.

In accordance with an exemplary embodiment of the present invention, the present invention includes a pipe heater comprising: (a) a heater body to be secured against a pipe, said heater body being provided with at least one heating element; (b) a securing strap system operable to secure said heater body to said pipe; and (c) a self-amalgamating material element. provided on said pipe heater to be engaged with a compatible material portion of said pipe heater to lock said securing strap system in a securing condition.

Accordingly, an additional aspect of the invention includes a method of attaching a pipe heater to a pipe, wherein said pipe heater comprises a heater body having at least one heater element and a securing strap system and said method comprises: (a) disposing said heater body on a pipe; and (b) operating said securing strap system to secure said heater body to said pipe, including engaging a self-amalgamating material element provided on said pipe heater with a compatible material portion provided on said pipe heater to lock said securing strap system in a securing condition in which said pipe heater is secured to said pipe.

According to a further aspect of the invention there is provided a pipe heater comprising: (a) a heater body to be secured against a pipe; (b) a securing strap system attached to said heater body and operable to secure said pipe heater body to said pipe; and (c) a self-amalgamating material element, wherein (i) said self-amalgamating material element is provided on one of said heater body and said securing strap system to be engaged with a compatible material portion of said pipe heater, and (ii) the arrangement of said a self-amalgamating material element and said compatible material portion is such that, in use, engagement of said a self-amalgamating material element and said compatible material portion locks said securing strap system in a condition securing said heater body to a pipe.

Accordingly, an additional aspect of the invention includes a pipe insulator comprising: (a) a thermal insulation body to be secured against a pipe; (b) a securing strap system operable to secure said thermal insulation body to said pipe; and (c) a self-amalgamating material element provided on said pipe insulator to be engaged with a compatible material portion of said pipe insulator to lock said securing strap system in a securing condition.

Additionally, a further aspect of the invention includes a securing strap system to secure a pipe heater or a pipe insulator to a pipe or other part of a pipe system, said securing strap system comprising a self-amalgamating material element provided to be engaged with a compatible material portion to lock said securing strap system in a securing condition.

While multiple embodiments are disclosed, still other embodiments of the present invention will become apparent to those skilled in the art from the following detailed description, which shows and describes illustrative embodiments of the invention. Accordingly, the detailed description is to be regarded as illustrative in nature and not. restrictive.

### DETAILED DESCRIPTION OF THE PREFERRED EMBODIMENTS

So that the invention may be readily understood, certain terms are first defined.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

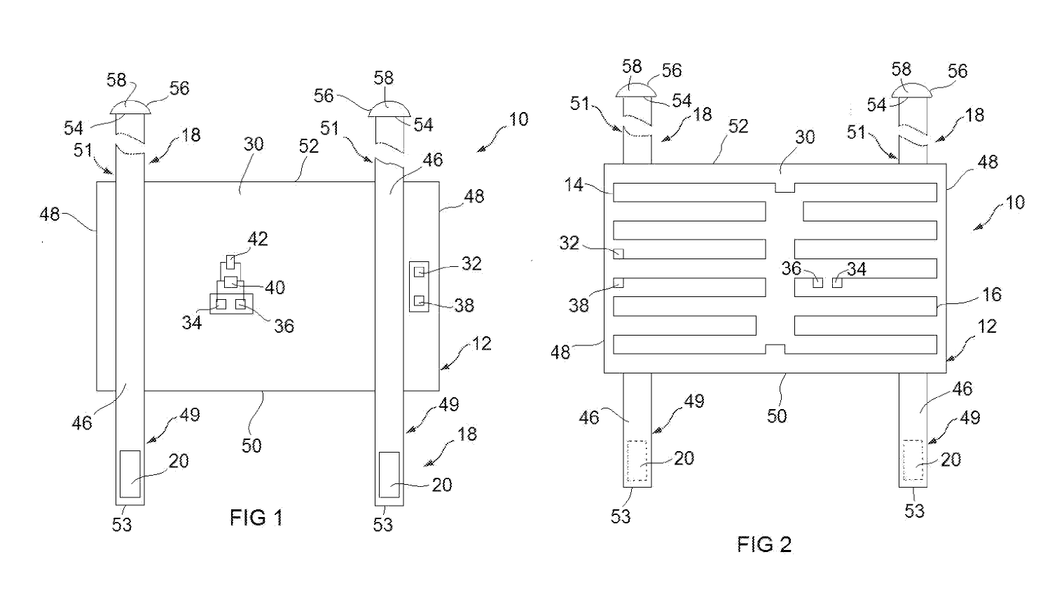

As illustrated in FIGS. 1 and 2, a pipe heater 10 comprises a heater body 12 to be secured against a pipe. The heater body 12 is provided with at least one heating element 14, 16. The pipe heater 10 has at least one securing strap system 18 that is operable to secure the heater body 12 to a pipe. A respective self-amalgamating material element 20 is provided on the pipe heater 10 to be engaged with a compatible material portion of the pipe heater 10 to lock each securing strap system 18 in a securing condition. In some examples, the compatible material portion may be a portion of the heater body 12, while in other examples the compatible material portion may be a portion of a securing strap system 18 and in still further examples the compatible material portion may be a further self-amalgamating material element 20 provided on the heater body 12 or a securing strap system 18.

The heater body 12 may comprise sheets 30 of silicone rubber between each heating element 14, 16 which is laminated. As illustrated in FIG. 2, there are two heating elements 14, 16 and the uppermost sheet (as viewed in the drawing) has been omitted to allow them to be seen. The heating element 14 has an input (upstream) terminal 32 and an output (downstream) terminal 34. Similarly, the, heating element 1,6 has an input (upstream) terminal 36 and an output (downstream) terminal 38. Each heating element 14, 16 follows a convoluted path between its input and output terminals. The convoluted paths of the heating elements 14, 16 are arranged such that the sheet of silicone rubber 30 is substantially covered by heating element 14, 16 so that heating will be substantially uniform across the entire surface area of the heater body 12. The terminals 32, 38 are to be connected with power leads to power the pipe heater 10. In some examples, the pipe heater 10 may be powered by an AC mains power source, which may be single or three-phase. However, in other embodiments, the pipe heater 10 may be powered by a DC power supply.

The terminals 34, 36 are bridged to provide electrical continuity. The terminals 34, 36 may be bridged by a temperature sensitive device 40. The temperature sensitive device 40 is operable to interrupt the supply of electrical energy through the pipe heater 10 if it is exposed to a temperature exceeding a set temperature. The temperature sensitive device 40 may comprise a heat sensitive switch such as a thermostat or a thermal fuse. In some examples the temperature sensitive device 40 may comprise a thermostat and thermal fuse in series. The pipe heater 10 may be provided with a fault indicating element 42 that activates to indicate when the temperature sensitive device 40 has operated to interrupt the supply of electrical energy through the pipe heater 10. The fault indicating element 42 may be a lighting element that illuminates when the temperature sensitive device 40 has operated to interrupt the supply of electrical energy through the pipe heater 10. The arrangement of the temperature sensitive device 40 and fault indicating element 42 may be as described in the Applicant's co-pending patent application titled ‘Fault Indicating Circuit for an Electric Heater’ (Applicant's Case .Reference: M14A204), the entire content of which is incorporated herein by reference.

The embodiment of the present invention as illustrated by FIGS. 1 and 2 includes two securing strap systems 18. This is not essential and in principle the pipe heater 10 may be provided with as many securing strap systems 18 as are considered desirable for securing the heater body 12 to a pipe. In some examples, one securing strap system 18 may be deemed sufficient. In general it is to be expected that the greater the length of the pipe heater 10, the greater will be the number of securing strap systems 18 needed and that a greater number of securing strap systems 18 will ensure more complete engagement with the pipe to which the pipe heater 10 is secured, thereby providing a better heat transfer relationship between the parts.

The securing strap systems 18 each comprise a single strap 46, which is fixed to the heater body 12. In the illustrated embodiment the strap systems 18 are disposed adjacent respective opposed ends of the heater body 12, which may be defined by respective edges 48 of the sheets 30 of silicone rubber. The straps 46 may be made of any suitable material and fixed to the heater body 12 by any suitable known fixing system. In embodiments in which the heater body 12 is made from silicone rubber, the straps 46 may also be made from silicone rubber and fixed to the heater body 12 by means of silicone putty or an RTV silicone adhesive. In other embodiments, silicone rubber straps 46 may be fixed to a heater body 12 made of silicone rubber by means of self-amalgamating material elements 20 in the form of lengths of self-vulcanizing silicone rubber tape disposed between the silicone rubber straps 46 and heater body 12.

Each silicone rubber strap 46 has a first strap portion 49 that extends from a first lengthways extending side 50 of the heater body 12 and a second strap portion 51 that extends from a second lengthways extending side 52 of the heater body 12. The first strap portion 49 includes a first free end 53 of the strap 46 and the second strap portion 51 includes a second free end 54 of the strap 46. Respective self-amalgamating material elements 20 are provided adjacent the first free ends 53 of the straps 46. The second free ends 54 of the straps 46 are provided with respective aperture members 56 that cooperate with the second free ends 54 to define apertures 58 through which the first free ends 53 of the straps 46 can be threaded. The aperture members 56 may be metallic rings that are held by respective loops provided at the second free ends 54 of the straps 46. The metallic rings may be D-rings.

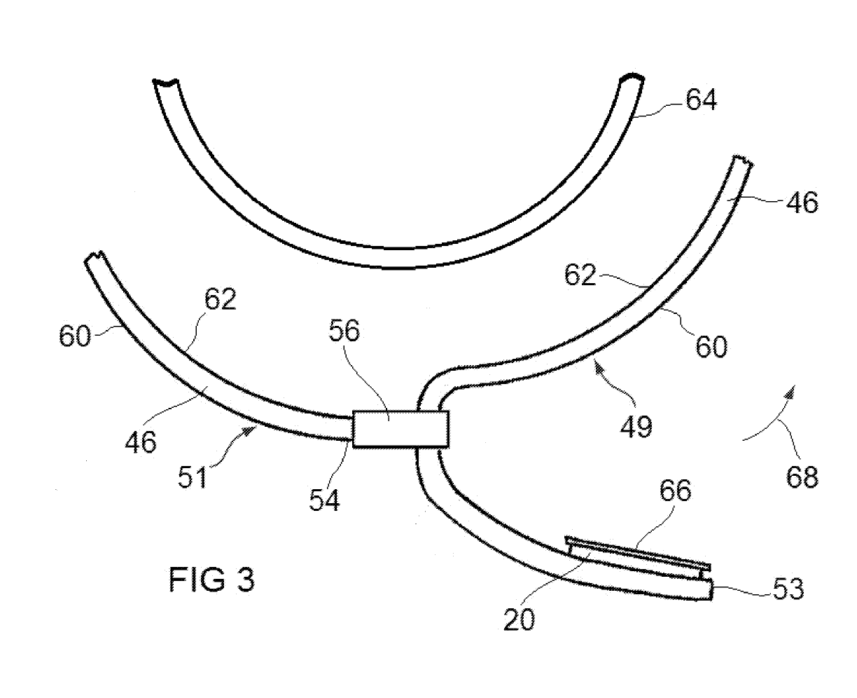

As illustrated in FIG. 3, the self-amalgamating material elements 20 are provided on a first, exterior, major face 60 of the strap 46. The exterior major face 60 is disposed in an opposed, spaced apart relationship with respect to a second, interior, major face 62 of the straps 46. In use, the interior major faces 62 face a pipe 64 to which the pipe heater 10 is attached and the exterior major faces 60 face generally radially outwardly with respect to the pipe 64. The outwardly facing major surface 60 of the self-amalgamating material element 20 is covered by a removable protective cover element 66 to prevent unwanted self-amalgamating by the self-amalgamating material element 20 during, for example, shipping and storage of the pipe heater 10 or fitting to a pipe 64. The removable protective cover element 66 may be a plastics film that can be removed by peeling it away from the self-amalgamating material element 20.

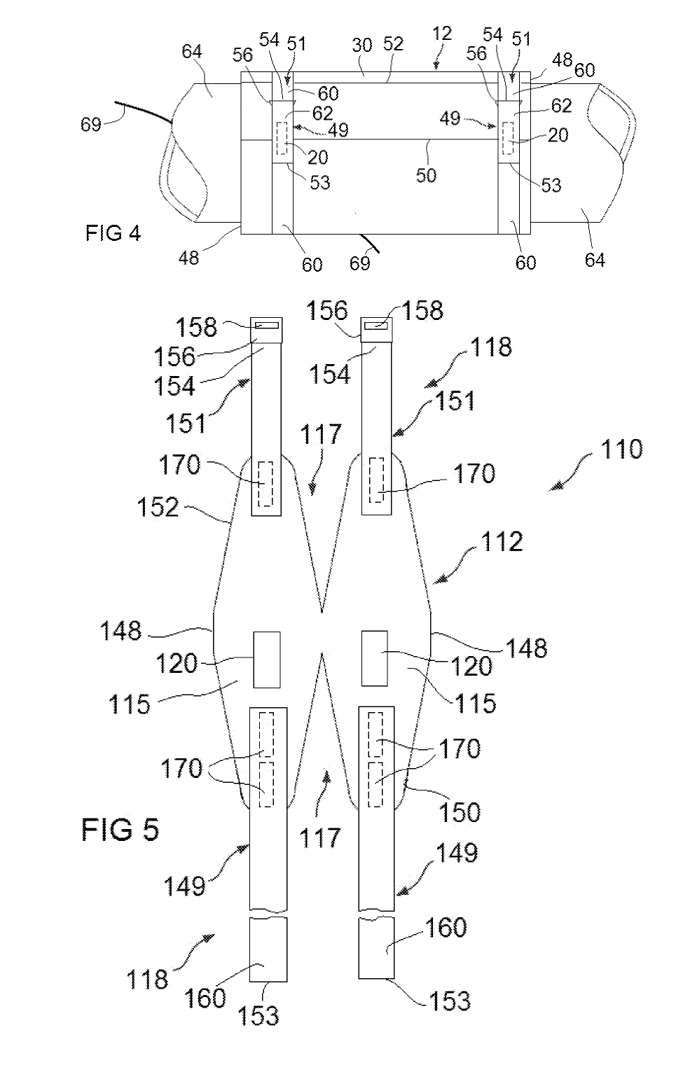

As illustrated in FIGS. 3 and 4, in use the heater body 12 is placed on the part of the pipe 64 that is to be heated and then wrapped around the pipe 64 so as to at least substantially enclose a desired length of the pipe 64. The securing strap systems 18 are then operated to secure the pipe heater 10 to the pipe 64 by first bringing together the first and second free ends 53, 54 of a strap 46 and threading the first free end 53 with the affixed self-amalgamating material element 20 through the aperture 58 defined by the strap 46 and aperture member 56. This may be achieved by holding the second strap portion 51 relatively still and moving the first strap portion 49 towards it, or simultaneously moving the two free ends 53, 54 towards one another. After passing through the aperture 58, the first free end 53 is turned away from the second strap portion 51 and moved in a direction 68 generally corresponding to the lengthways direction of the first strap portion 49 towards the first side 50 of the heater body 12. The pull of the first free end 53 of the strap 46 against a fulcrum defined by the aperture member 58 tightens the strap 46 and heater body 12 around the pipe 64.

Once the strap 46 has been tightened sufficiently to hold the heater body 12 securely against the pipe 64, the first free end 53 is pressed towards the pipe 64 to bring the self-amalgamating material element 20 into engagement with a compatible material portion of the pipe heater 10 to lock the securing strap system 18 in a securing condition. In the illustrated example the compatible material portion is a portion of the exterior major face 60 of the strap 46. In examples in which the strap 46 is not made of a compatible material, a patch or patches of compatible material may be secured to the strap 46.

Electrical leads 69 may be secured to the terminals 32, 38 to supply electrical energy to power the pipe heater 10. Once the electrical leads 69 are secured to the terminals 32, 38 they may be covered by an electrically insulating patch (not shown). In examples provided with a temperature sensitive device 40 and faulting indicating element 42, the terminals 34, 36 and temperature sensitive device 40 may likewise be covered by an electrically insulating patch, leaving just the fault indicating element 42 exposed.

The pipe heater 10 as described above is configured for fitting to generally straight lengths in a pipe system and primarily for fitting to straight lengths of pipe. FIG. 5 illustrates a pipe heater 110 that is configured for fitting to curved portions of a pipe system such as a curved or bent pipe or an elbow joint. The pipe heater 110 may be configured for fitting to curved or bent pipes, or elbow joints, that make any angle, including angles greater and less than 90°. Parts of the pipe heater 110 that are the same as, or similar to, parts of the pipe heater 10 are indicated by the same reference numeral incremented by 100 and may not be described in detail again.

The pipe heater 110 comprises a heater body 112 and two securing strap systems 118. Respective self-amalgamating material elements 120 are provided on the heater body 112.

The heater body 112 is provided with one or more heating elements and with terminals by which the heating element(s) may be connected with an electrical power source.

The heater body 112 may also be provided with a temperature sensitive device and fault indicating element in analogous fashion to the pipe heater 10 as described above. These features are not illustrated in FIG. 5 to allow other features shown by the drawing to be more clearly shown.

In this particular embodiment the heater body 112 is shaped such that it comprises two approximately rhomboid sections, or portions, 115 disposed in adjoining side-by-side relation. Generally V-shaped gaps 117 are defined between the rhomboid sections 115 providing the heater body 112 with additional flexibility when compared with the heater body 12. This flexibility facilitates fitting around a curved pipe or elbow joint. In the illustrated embodiment the heater body 112 comprises two rhomboid sections 115. It will be understood that additional rhomboid sections 115 may be added to provide pipe heaters that have a greater length for fitting to longer curved pipes or elbow joints and each rhomboid section will be provided with a securing strap system 118.

Each rhomboid section 115 is provided with a securing strap system 118. Although not essential, in the illustrated embodiment each securing strap system 118 comprises a first strap portion 149 and a second strap portion 151 made of separate lengths of strap material 146. The securing strap portions 149, 151 are secured to the heater body 112 by respective lengths of self-amalgamating material 170 disposed between the securing strap portions 149, 151 and the heater body 112.

The free ends 154 of the second strap portions 151 are provided with aperture members 156. The aperture members 156 may comprise tabs fixed to the free ends 154 and may wholly define the respective apertures 158 through which the free ends 153 of the first strap portions 149 can be threaded. The aperture members 156 may have a generally rectangular outline.

Optionally, the pipe heater 112 may be supplied in kit form with a separate heater body 112 and securing strap system(s) 118 that can be fitted to the heater body 112 on site. In such examples, the strap portions 149, 151 may be supplied in relatively longer lengths to facilitate fitting to relatively larger diameter pipes and the installer may trim the strap portions 149, 151 prior to securing them to the heater body 112 to provide a pipe heater 110 for relatively smaller diameter pipes. The lengths of self-amalgamating material 170 may be supplied separately or pre-fixed to the heater body 112. The strap portions 149, 151 may be secured to the heater body 112 by one or more lengths of self-amalgamating material 170 as desired. In other embodiments, a suitable adhesive, rather than lengths of self-amalgamating material 170, may be provided for securing the securing strap system 118 to the heater body 112.

In use, the pipe heater 110 is fitted to a pipe system in analogous fashion to the pipe heater 10 with the securing strap systems 118 being locked in a securing condition by engagement between the exterior major faces 160 of the first strap portions 149 and the self-amalgamating material elements 120 provided on the heater body 112.

In cases in which it is wished to reuse a pipe heater 10, 110, the old straps 46, 146, or strap portions, can be cut, or otherwise removed, from the heater body 12, 112 and a new strap 46, 146, or strap portions, fitted to the body. Securing strap systems such as the securing strap systems 18, 118 may be supplied separately for this purpose.

The illustrated embodiments have been described in the context of pipe heaters secured to pipes in a pipe system. It is envisaged that pipe heaters embodying the described principles may be configured for fitting to other parts of a pipe system such as valves.

For pipe heaters operating at generally higher temperatures, for example 180 to 200° C., self-amalgamating material elements 20, 170 comprising a self-vulcanizing silicone rubber may be used. In other examples, the self-amalgamating material elements 20, 170 may comprise ethylene polypropylene rubber (EPR) or polyisobutylene (FIB). Securing strap systems 18, 118 using EPR or PIB self-amalgamating tapes for locking may be suitable for lower temperature applications. Pipe heaters utilising EPR or FIB self-amalgamating material elements may, for example, be used for gas delivery lines.

The illustrated embodiments show securing strap systems associated with heater bodies. The securing strap systems may, for example, be secured to the heater bodies by suitable adhesives, lengths of self-amalgamating material or stitching, according to the materials from which the heater bodies and securing strap systems are made and the desired construction of the pipe heater. The securing strap systems can be tightened around a pipe or similar body to secure the heater body to the pipe/body. A self-amalgamating material element provided on the pipe heater can be engaged with a compatible material portion provided on the pipe heater to lock the securing strap system in a securing condition. The self-amalgamating material element may be a tape or patch of a self-amalgamating material. The self-amalgamating material element may be provided on the securing strap system or the heater body. The compatible material portion may be a portion of the heater body or the securing strap system. The heater body or securing strap system may be made of the compatible material. Alternatively the compatible material portion may be a patch or length of compatible material secured to the heater body or securing strap system. The compatible material portion may be a length of self-amalgamating tape.

The illustrated embodiments of pipe heaters embody a securing strap system that allows quick and easy fitting and securing of a pipe heater to a pipe or other part of a pipe system. In order to secure the pipe- heater in place, it is merely necessary to thread, or feed, a first securing strap portion through an aperture provided on a second strap portion, pull tight and then press the first strap portion towards the pipe to engage the self-amalgamating material element(s) and lock the securing strap system in a securing condition. This can be achieved one handed. The speed of fitting may be generally advantageous, while the simple, even one-handed, mode of securing and locking may be advantageous when the installation is taking place in an area that is difficult to access or when, due to the working environment, the installer has to wear gloves. A further advantage may be that once locked, the securing strap should remain in a securing condition until such time as it is decided to remove the pipe heater as the likelihood of the securing strap system working loose may be reduced.

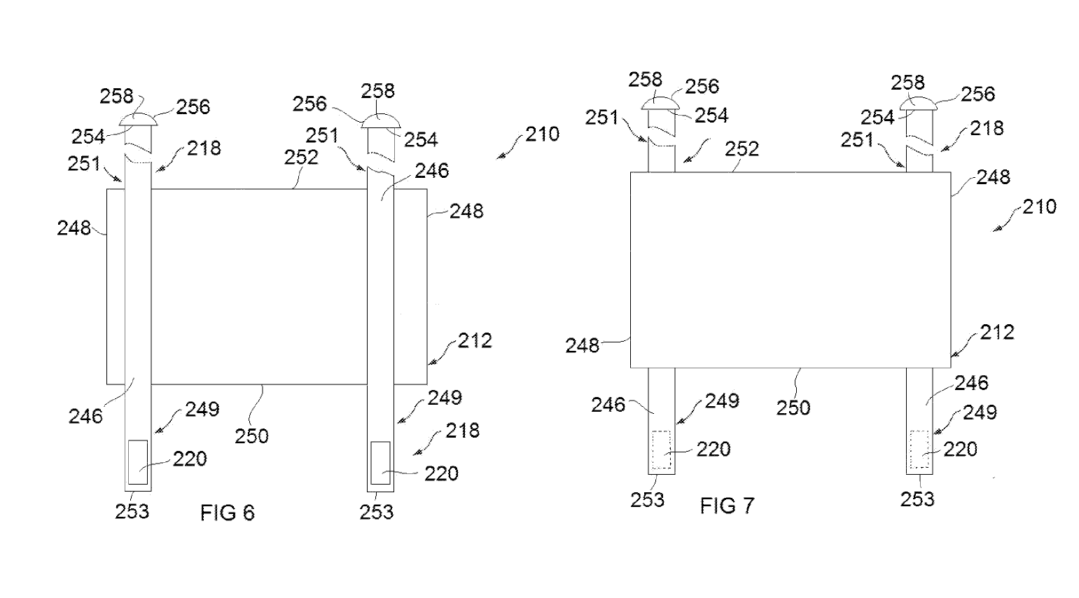

The strap securing systems have been described as parts of, or for use with, pipe heaters. Securing strap systems embodying the disclosed methodology may be used in securing other bodies to pipe systems. For example, the securing strap systems 18, 118 may be used analogously to secure thermal insulation bodies to a pipe system rather than heater bodies such as the heater bodies 12, 112. An embodiment of a pipe insulator 210 utilising a securing strap system 218 is shown in FIGS. 6 and 7. The pipe insulator 210 comprises a thermal insulation body 212 and two securing strap systems 218. The only difference between the pipe insulator 210 and the pipe heater 10 is that a thermal insulation body 212 is provided in place of a heater body and so parts of the pipe insulator corresponding to parts of the pipe heater are indicated by the same reference numeral incremented by 200.

The embodiment of the present invention illustrated by FIGS. 6 and 7 includes two securing strap systems 218. This is not essential and in principle the pipe heater 210 may be provided with as many securing strap systems 218 as are considered desirable for securing the thermal insulation body 212 to a pipe. In some examples, one securing strap system 218 may be deemed sufficient, In general it is to be expected that the greater the length of the pipe insulator 210, the greater will be the number of securing strap systems 218 needed and that a greater number of securing strap systems 218 will ensure more complete engagement with the pipe to which the pipe insulator 210 is secured.

The securing strap systems 218 each comprise a single strap 246, which is fixed to the heater body 212. In the illustrated embodiment the strap systems 218 are disposed adjacent respective opposed ends of the thermal insulation body 212, which may be defined by respective edges 48 of the thermal insulation body 212. The straps 246 may be made of any suitable material and fixed to the thermal insulation body 212 by any suitable known fixing system. In some embodiments the thermal insulation body 212 may include an outer layer or patches made from silicone rubber, in which case, the straps 246 may also be made from silicone rubber and fixed to the thermal insulation body 212 by means of silicone putty or an RTV silicone adhesive. In other embodiments, silicone rubber straps 246 may be fixed to a thermal insulation body 212 having an outer layer made of silicone rubber by means of self-amalgamating material elements in the form of lengths of self-vulcanizing silicone rubber tape disposed between the silicone rubber straps 246 and thermal insulation body 212.

Each silicone rubber strap 246 has a first strap portion 249 that extends from a first lengthways extending side 250 of the thermal insulation body 212 and a second strap, portion 251 that extends from a second lengthways extending side 252 of the thermal insulation body 212. The first strap portion 249 includes a first free end 253 of strap 246 and the second strap portion 251 includes a second free end 254 of the strap 246. Respective self-amalgamating material elements 220 are, provided adjacent the first free ends 253 of the straps 246. The second free ends 254 of the straps 246 are provided with respective aperture members 256 that cooperate with the second free ends 254 to define apertures 258 through which the first free ends 253 of the straps 246 can be threaded. The aperture members 256 may be metallic rings that are held by respective loops provided at the second free ends 254 of the straps 246. The metallic rings may be D-rings.

The self-amalgamating material elements 220 are provided on a first, exterior, major face of the strap 246. The exterior major face is disposed in an opposed, spaced apart relationship with respect to 4 second, interior, major face of the straps 246. In use, the interior major faces face a pipe to which the pipe insulator 210 is attached and the exterior major faces face generally radially outwardly with respect to the pipe. The outwardly facing major surface of the self-amalgamating material element 220 is covered by a removable protective cover element (not shown, but optionally corresponding to the removable protective cover 66 shown in FIG. 3) to prevent unwanted self-amalgamating by the self-amalgamating material element 220 during, for example, shipping and storage of the pipe insulator 210 or fitting to a pipe The removable protective cover element may be a plastics film that can be removed by peeling it away from the self-amalgamating material element 220.

The thermal insulation body 212 is shown having a rectangular profile. It is to be understood that this is not essential and that the thermal insulation body may be shaped to fit a particular pipe configuration or other part of a pipe system such as a valve. The thermal insulation body 212 may, for example, have cut-outs analogous to those of the pipe heater 110 to enable fitting to a curved or bent pipe or a pipe elbow. The thermal insulation body 212 may comprise one or more pieces of thermal insulation material assembled to form a body. For example, the thermal insulation body 212 may comprise a plurality of layers of thermal insulation material disposed one upon another. The thermal insulation body 212 may provide layers that are not provided for thermal insulation purposes. For example, an outer layer to provide protection for an inner thermally insulating layer(s) may by provided. The outer layer may be made from a material selected to be compatible with the self-amalgamating material element(s) 220.

Obviously, many modifications and variations of the invention as hereinbefore set forth can be made without departing from the spirit and scope thereof, and, therefore, only such limitations should be imposed as are indicated by the appended claims.

We claim:

1. A pipe heater comprising:
(a) a heater body to be secured against a pipe, said heater body being provided with at least one heating element;
(b) a securing strap system operable to secure said heater body to said pipe; and
(c) a self-amalgamating material element provided on said pipe heater to be engaged with a compatible material portion of said pipe heater to lock said securing strap system in a secured condition.

2. A pipe heater as claimed in claim 1, wherein said self-amalgamating material element is provided on said securing strap system.

3. A pipe heater as claimed in claim 1, wherein said self-amalgamating material element is provided on said heater body.

4. A pipe heater as claimed in claim 1, wherein said self-amalgamating material element is covered with a removable protective cover element to prevent unwanted self-amalgamating by said self-amalgamating material element.

5. A pipe heater as claimed in claim 1, wherein said self-amalgamating element is made from silicone rubber, ethylene propylene rubber, or polyisobutylene.

6. A pipe heater as claimed in claim 1, wherein said securing strap system is fixed to said heater body.

7. A pipe heater as claimed in claim 6, wherein said securing strap system is fixed to said heater body by at least one self-amalgamating material element disposed between said heater body and said securing strap system.

8. A pipe heater has claimed in claim 1, wherein said securing strap system has a first end and a second end and said second end is provided with an aperture member that at least partially defines an aperture for threading through said first end.

9. A method of attaching a pipe heater to a pipe, wherein said pipe heater comprises a heater body having at least one heater element and a securing strap system and said method comprises:
(a) disposing said heater body on a pipe; and
(b) operating said securing strap system to secure said heater body to said pipe, including engaging a self-amalgamating material element provided on said pipe heater with a compatible material portion provided on said pipe heater to lock said securing strap system in a securing condition in which said pipe heater is secured to said pipe.

10. A method as claimed in claim 9, further comprising removing a protective cover element from said self-amalgamating material element prior to engaging said self-amalgamating material element with said compatible material portion.

11. A method as claimed in claim 9, wherein said securing strap system comprises a strap having a First strap portion extending from a first side of said heater body and a second strap portion extending from a second side of said heater body, said first strap portion includes a first end of said strap, said second strap portion includes a second end of said strap and said second end is provided with an aperture member that at least partially defines an aperture for threading through said first end.

12. A method as claimed in claim 11, wherein said securing strap further comprises threading said first end through said aperture and drawing said first end away from said second end to tighten said strap about said pipe.

13. A method as claimed in claim 9, wherein said self-amalgamating material element is provided on said first strap portion and at least one of said heater body and said strap comprises a said compatible material portion.

14. A method as claimed in claim 13, wherein the method further comprises pressing said first strap portion towards said pipe to engage said self-amalgamating material element with said compatible material portion.

15. A method as claimed in claim 9, further comprising providing at least one length of self-amalgamating material piece on said heater body or said securing strap system and pressing said heater body and securing strap system together to fix said securing strap system to said heater body with said at least one length of self-amalgamating material prior to operating said securing strap portion.

16. A pipe heater comprising:
(a) a heater body to be secured against a pipe;
(b) a securing strap system attached to said heater body and operable to secure said pipe heater body to said pipe; and
(c) a self-amalgamating material element, wherein
(i) said self-amalgamating material element is provided on one of said heater body and said securing strap system to be engaged with a compatible material portion of said pipe heater, and
(ii) the arrangement of said self-amalgamating material element and said compatible material portion is such that, in use, engagement of said self-amalgamating material element and said compatible material portion locks said securing strap system in a condition securing said heater body to a pipe.

17. A pipe heater as claimed in claim 16, wherein said compatible material portion is disposed on said heater body and is defined by the material from which an outer surface of said heater body is made or said securing strap system and is defined by the material from which a surface of said securing strap system is made.

18. A pipe heater as claimed in claim 16, wherein said self-amalgamating material element is provided on said securing strap system.

19. A pipe heater as claimed in claim 18, wherein said self-amalgamating material element comprises a self-amalgamating tape provided adjacent a free end of said securing strap system.

20. A pipe heater as claimed in claim 16, wherein said securing strap system comprises a first strap portion and a second strap portion and said second strap portion is provided with an aperture member that at least partially defines an aperture through which said first strap portion can be threaded to tighten said securing strap system.

21. A pipe heater as claimed in claim 16, wherein said securing strap system is fixed to said heater body by at least one self-amalgamating material element disposed between said heater body and said securing strap system.

22. A pipe insulator comprising:
(a) a thermal insulation body to be secured against a pipe;
(b) a securing strap system operable to secure said thermal insulation body to said pipe; and
(c) a self-amalgamating material element provided on said pipe insulator to be engaged with a compatible material portion of said pipe insulator to lock said securing strap system in a securing condition.
